(19) United States
(12) Patent Application Publication
(10) Pub. No.: US 2026/0267716 A1
(43) Pub. Date: Sep. 10, 2026

(54) ASYNCHRONOUS PIPELINE OBSERVABILITY USING SERVICE LEVEL OBJECTIVES

(71) Applicant: eBay Inc., San Jose, CA (US)

(72) Inventors: Jash Rasesh Mistry, San Francisco, CA (US); Gabriela Medvetska, San Francisco, CA (US); Ramprasad Ellupuru, Dublin, CA (US)

(21) Appl. No.: 19/074,096

(22) Filed: Mar. 7, 2025

(51) Int. Cl. G06F 9/54

(52) U.S. Cl. CPC G06F 9/542; G06F 9/546

(57) ABSTRACT

An asynchronous monitoring system is disclosed, designed to enhance service level objectives (SLO) and service level indicators (SLI) in computing environments. The system comprises an asynchronous application that receives events via an event queue, processes them to generate event statuses and measured processing times, and holds this data in a response queue. The system calculates an availability metric by dividing successful events by total events, determines SLOs based on this metric, and generates alerts if metrics fall outside preset ranges.

### TECHNICAL FIELD

The present disclosure relates to computer networking technologies, specifically to asynchronous monitoring systems utilizing service level objectives (SLOs) for enhancing observability and alerting in asynchronous pipelines.

### BACKGROUND

Service Level Objectives (SLOs) help ensure that services are reliable and perform well. SLOs traditionally operate with systems that use a clear request-response model, where it is easy to define and measure success. However, as technology becomes more complex, including systems that do not follow a simple request-response pattern, using SLOs becomes more difficult. In these cases, it is hard to define and measure success in a way that fits traditional SLO frameworks.

Many existing tools for monitoring and managing service performance struggle in complex systems. Without effective tools and methods for implementing Service Level Objectives (SLOs) in these contexts, organizations may experience inefficiencies, delayed issue detection, and reduced service quality.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating the architecture of an asynchronous monitoring system integrated with SLI and SLO dashboards in accordance with some example embodiments.

FIG. 2 is a block diagram illustrating the architecture of an asynchronous monitoring system in accordance with some example embodiments.

FIG. 3 is a block diagram illustrating the integration of synchronous and asynchronous SLOs with monitoring and alert systems in accordance with some example embodiments.

FIG. 4 is a flow chart diagram illustrating the process of handling events in an asynchronous pipeline in accordance with some example embodiments.

FIG. 5 illustrates a routine in accordance with some example embodiments.

FIG. 6 is a block diagram illustrating the architecture of a computer system used in the asynchronous monitoring system in accordance with one example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Traditional systems often rely on synchronous request-response patterns, where the performance and reliability of services are assessed based on the immediate feedback from each request. While this method works well for certain applications, it presents challenges when applied to asynchronous systems. Asynchronous systems, which are characterized by non-blocking operations and event-driven architectures, do not provide immediate feedback. This lack of prompt responses makes it difficult to measure and ensure service reliability and performance using traditional methods.

Currently, service-level management primarily focuses on synchronous systems. These systems utilize service level indicators (SLIs) to define and assess service performance, typically categorizing events as either valid or good based on their immediate outcomes. However, this approach is not directly applicable to asynchronous systems, where events can be processed at different times, and outcomes may not be immediately visible. As a result, existing solutions lack a comprehensive framework for defining and measuring service level objectives (SLOs) in asynchronous environments, leading to potential gaps in monitoring service reliability and performance.

This application addresses these challenges by introducing a method for implementing SLOs in asynchronous systems. This approach broadens the definitions of valid and good events to include asynchronous pipelines, allowing for accurate measurement and management of service performance. Good events are defined as those that are ultimately marked as successful and processed within a specified timeframe, ensuring reliability in asynchronous environments. This method enhances the observability of asynchronous systems and enables quicker detection and resolution of issues, ultimately improving overall service availability and customer satisfaction.

In some example embodiments, the method involves receiving asynchronous events at an asynchronous application within an asynchronous monitoring system via an event queue. The asynchronous application processes these events, generates an event status, and measures the processing time for each event. The event status indicates the processing outcome, while the measured processing time includes both the queue waiting time and the processing time in the application. A processed event is defined as successful if its event status indicates success and its processing time falls within a predetermined threshold duration. Additionally, all processed events are counted as total events, regardless of their processing outcomes. This includes both successful asynchronous events, which meet predefined success criteria, and unsuccessful asynchronous events, which may have failed or required retries.

The event status and measured processing time for each asynchronous event are stored in a response queue. Over a defined time period, the method calculates an availability metric by dividing the number of successful events by the total number of events from the response queue. It also calculates a latency metric by determining the total time each event spends in the event queue, the asynchronous application, and the response queue, dividing the number of events processed within the predetermined threshold duration by the total number of events from the response queue. A service level objective is then determined based on the availability metric, latency metric, and a preset range. Finally, an alert notification is generated if either the availability metric or the latency metric falls outside the preset range.

The methodologies described in this document aim to address the technical challenge of accurately monitoring the performance of asynchronous systems, among others. In some example embodiments, the method manages asynchronous events by integrating event processing with real-time monitoring and alerting. Successful events are defined based on both processing outcomes and time thresholds, ensuring that events meeting specific criteria contribute to the availability metric. This approach allows for precise monitoring of system performance and helps detect anomalies or performance degradations.

In some example, the term “event” refers to an occurrence or action that is detected and processed by a system. Examples of events include user-initiated actions such as submitting a form, system-generated tasks like data synchronization, or external interactions such as API requests. Each type of event may have criteria that determine its success and contribute to the availability metric.

In some example, the term “criteria” refers to conditions that are used to evaluate or determine the success, validity, or quality of a process, event, or outcome. These criteria serve as guidelines or benchmarks for the system.

In one example criteria, a user-initiated action is successful if it is processed within a specified time frame and results in a confirmation message being sent back to the user. A system-generated task, such as data synchronization, is successful if it completes without errors and updates the relevant database entries. An API request could be considered successful if it receives a valid response from the external service within a certain latency threshold.

In some example, the “availability metric” refers to a measure used to assess the ability of a system to successfully process events or requests within a specified period. For example, the availability metric is calculated by dividing the number of successful events by the total number of events over a defined time frame. A higher availability metric indicates that a larger proportion of events are being processed successfully, suggesting that the system is performing well and meeting its service level objectives (SLOs). Conversely, a lower availability metric suggests that a larger number of events are failing or not meeting the success criteria, indicating potential issues with system performance or reliability.

For example, a high availability metric might be 99.9%, meaning that 99.9% of events are processed successfully, reflecting a robust and reliable system. A low availability metric might be 85%, indicating that 15% of events are failing or not meeting the success criteria, which could signal underlying problems that need to be addressed.

In some example, the term “latency metric” is a measure used to quantify the time delay experienced in the system. The latency metric represents the time taken for a data packet or event to travel from its source (client) to its destination (application service), including any processing time within the system. The latency metric helps assess the performance and responsiveness of the system by indicating how quickly it can process and respond to requests or events.

The availability metric and latency metric affect the service level objective by serving as a key performance indicator. SLOs are defined in terms of availability targets, such as ensuring that 99% of events are processed successfully within a given time frame. If the availability and latency metrics falls below the defined SLO threshold, the system triggers alerts and prompts system administrators to investigate and resolve the issues causing the deviation.

The configuration of components, which includes the event queue, asynchronous application, and response queue, enables parallel processing and real-time data collection. This setup enhances the system's capacity to handle high volumes of asynchronous events without bottlenecks, ensuring timely processing and accurate metric calculations.

By incorporating both queue waiting time and processing time into the overall measured processing time, the method provides a comprehensive view of event handling efficiency, thereby addressing a gap in current asynchronous monitoring practices. In practical applications, this method can be implemented in systems that utilize asynchronous event processing, such as data pipelines or event-driven architectures. Additionally, the system can generate alert notifications based on SLO violations, allowing operators to respond quickly to issues and maintain service reliability and performance. This method effectively addresses the challenges of monitoring and managing asynchronous events.

As a result, one or more of the methodologies described may reduce the need for certain efforts or computing resources that would otherwise be necessary for monitoring and managing asynchronous events. Consequently, the resources utilized by machines, databases, or devices within the environment may be diminished. Examples of such computing resources include processor cycles, network traffic, memory usage, data storage capacity, power consumption, network bandwidth, and cooling capacity.

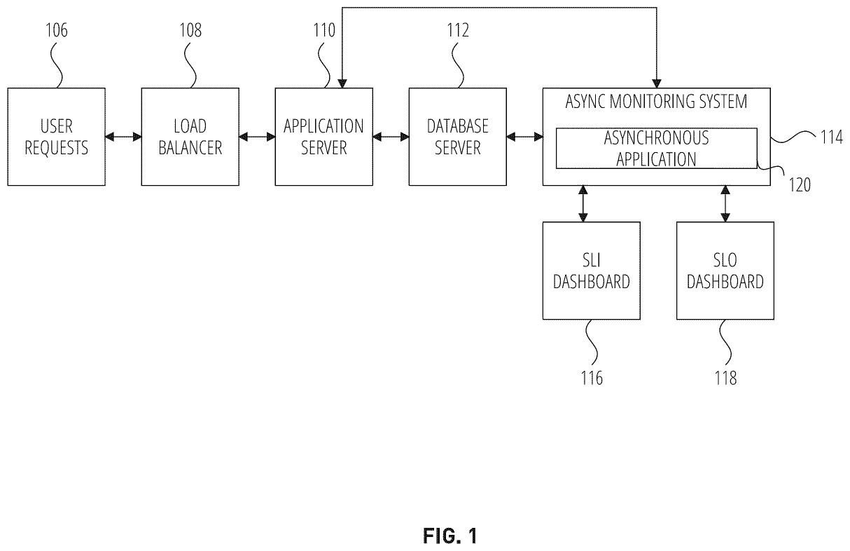

FIG. 1 is a block diagram illustrating the architecture of an asynchronous monitoring system integrated with SLI and SLO dashboards in accordance with some example embodiments. User requests 106 originate from end-users and are directed towards the application server 110 for processing. User requests 106 encompass actions such as data retrieval, updates, or service requests, depending on the context of the application. These requests are transmitted over a network and are received by the load balancer 108.

The load balancer 108 distributes incoming user requests 106 across the application server 110. This distribution allows for optimizing resource utilization to maintain availability and system performance. The load balancer 108 can implement various algorithms, such as round-robin, least connections, or IP hash, to determine the appropriate application server 110 for each request.

The application server 110 processes the requests received from the load balancer 108. The application server 110 executes the business logic to fulfill the user requests 106, which may involve computations, data manipulation, or interactions with other system components.

Database server 112 functions as the data storage and retrieval Component within the system. The database server 112 can be implemented using relational databases, NoSQL databases, or other data storage solutions, depending on the data model and access patterns. The database server 112 interacts with the application server 110 to provide data for processing requests and also support complex queries and transactions.

The asynchronous monitoring system 114 provides real-time observability and monitoring of the system's performance. In some example embodiments, the async monitoring system 114 includes an asynchronous application 120 that collects and analyzes metrics related to the processing of user requests 106, such as response times, error rates, and throughput.

The asynchronous application 120 performs various jobs/functions, from interacting with the database server 112 (e.g., reading/writing) to interacting with other synchronous/asynchronous applications. These functions may also be referred to as “events.” In one example, an event includes any job or service regardless of whether there is a metric for it.

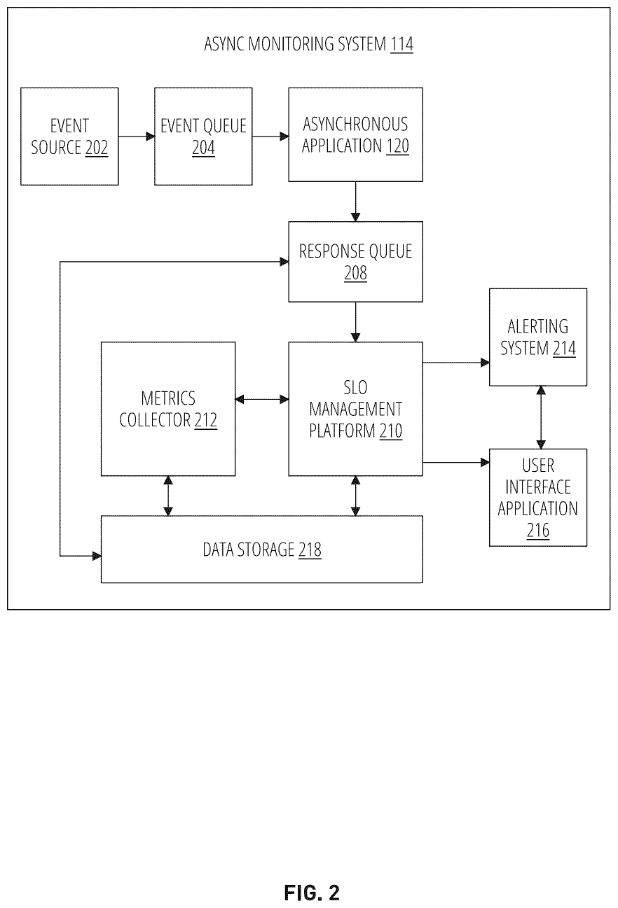

Operating independently of the main processing flow, the asynchronous monitoring system 114 handles large volumes of data without impacting the performance of the application server 110 or database server 112. In some example embodiments, the async monitoring system 114 processes the asynchronous events in parallel and utilizes a plurality of processing threads. Some example embodiments of the async monitoring system 114 are described in more detail below with respect to FIG. 2.

The SLI dashboard 116 is a user interface component that displays SLIs collected by the asynchronous monitoring system 114. SLIs are metrics that provide insights into the performance and reliability of the system, such as latency, availability, and error rates. The SLI dashboard 116 allows system administrators and operators to visualize these metrics in real time, facilitating the identification of trends, anomalies, and potential issues.

The SLO dashboard 118 complements the SLI dashboard 116 by focusing on service level objectives (SLOs), which are predefined targets for system performance and reliability. The SLO dashboard 118 provides a high-level overview of the system's compliance with these objectives, highlighting any deviations or violations.

In some example embodiments, the async monitoring system 114 is designed to provide real-time feedback to the application server 110 by continuously evaluating the SLOs and SLIs for deviations. When deviations from the predefined SLOs or SLIs are detected, the async monitoring system 114 generates alert notifications that are sent to the application server 110. These alerts include detailed metrics and analysis that help identify and pinpoint specific issues affecting performance, such as increased latency or reduced availability. By leveraging this feedback, the application server 110 can dynamically adjust configurations or settings to address the identified issues. This may involve reallocating resources, modifying processing priorities, or implementing load-balancing strategies to enhance the overall performance and reliability of the application.

For example, upon receiving feedback from the asynchronous monitoring system indicating deviations from the established SLOs or SLIs, the application server 110 can undertake several reconfiguration strategies to enhance performance. For instance, if the async monitoring system 114 identifies increased latency due to high processing loads, the application server 110 might reallocate computational resources by increasing the number of processing threads or instances dedicated to handling incoming requests. This can be achieved through horizontal scaling, where additional server instances are deployed to distribute the load more evenly.

In cases where the feedback highlights bottlenecks in specific application components, such as database queries or external API calls, the application server 110 can optimize these operations by implementing caching mechanisms or query optimizations to reduce response times. Additionally, if the async monitoring system 114 detects a pattern of failures or retries, the application server 110 might adjust timeout settings or retry logic to handle transient errors better, thereby improving the success rate of processed events.

Furthermore, the application server 110 can utilize the feedback to implement dynamic load balancing strategies, redistributing incoming requests based on real-time performance metrics to ensure that no single server instance becomes overwhelmed. This might involve adjusting the load balancer's algorithm to prioritize underutilized resources or to route traffic based on the current health status of server instances.

By continuously analyzing the detailed metrics and insights provided by the async monitoring system 114, the application server 110 can proactively tweak configurations, such as adjusting memory allocation, modifying thread pool sizes, or fine-tuning garbage collection settings to optimize performance. These adjustments not only address immediate performance issues but also contribute to long-term system stability and efficiency, ensuring that the application server 110 consistently meets or exceeds the defined SLOs and SLIs.

FIG. 2 is a block diagram illustrating the architecture of an asynchronous monitoring system in accordance with some example embodiments. The async monitoring system 114 includes an event source 202, an event queue 204, an asynchronous processor 206, a response queue 208, a SLO management platform 210, a metrics collector 212, an alerting system 214, a user interface application 216, and a data storage 218.

The event source 202 includes events that need to be processed. These events can come from various origins, such as user interactions, system logs, or external data feeds. The event source 202 manages a high volume of incoming data, ensuring that events are captured in real-time and forwarded to the event queue 204.

The event queue 204 acts as a buffer between the event source 202 and the asynchronous processor 206. This queue temporarily holds events until they can be processed, allowing the system to manage varying loads and avoid bottlenecks. For scalability and fault tolerance, the event queue 204 is implemented as a distributed message queue. The term “distributed message queue” refers to a messaging system that facilitates communication between different components of a distributed system. It allows messages to be stored and retrieved across multiple servers or nodes. Distributed message queues are used in asynchronous processing environments to decouple the components of the system, enabling them to operate independently and efficiently.

The event queue 204 also maintains the order of events and interacts with the asynchronous processor 206 by delivering events for processing.

The asynchronous processor 206 processes events in parallel, using multiple processing threads to improve throughput and efficiency. It performs various operations on the events, such as data transformation, validation, and enrichment, before determining the status of each event.

The status of an event refers to the outcome or result of its processing within a system. The status indicates whether the event was successfully processed, encountered errors, or required retries. Event statuses are used to determine the success and reliability of the system with respect to SLOs.

### EXAMPLES OF EVENT STATUSES FOR VALID EVENTS

Processed: The event has been successfully processed, regardless of the outcome.
Failed: the event encountered an error during processing and did not complete successfully.
Retried: the event required one or more retries due to transient errors or failures during initial processing attempts.
Pending: the event is still in the queue and awaiting processing.
Examples of Event Statuses for Good Events:
Successful: the event was processed successfully within the specified time frame and met all success criteria.
Completed: the event finished processing without errors and within a preset latency threshold.
Acknowledged: the event was successfully completed, and a confirmation was sent back to the originating source.

In some example embodiments, valid events include all events that enter the processing pipeline, regardless of their final status, while good events are those that are successfully processed and meet the defined success criteria, such as processing within a preset time frame.

The response queue 208 serves as a holding area for events that have already been processed by the asynchronous processor 206. It ensures that the results of the processing are stored until they can be analyzed further by the SLO management platform 210. Similar to the event queue 204, the response queue 208 can also be implemented as a distributed message queue. It interacts with the SLO management platform 210 to provide data used for calculating service level objectives and with the alerting system 214 to trigger alerts based on the processed event data. In some example embodiments, the response queue 208 logs and stores the event status and processing time of each event in a metrics database (e.g., data storage 218).

The SLO management platform 210 defines, monitors, and manages SLOs within the async monitoring system 114. It collects metrics from the response queue 208 and the metrics collector 212 to evaluate the system's performance against predefined SLOs. The SLO management platform 210 provides a centralized interface for configuring SLOs, viewing performance metrics, and generating reports. The SLO management platform 210 communicates with the alerting system 214 to trigger alerts when SLOs are violated and interacts with the user interface application 216 to grant users access to SLO configurations and performance data.

The metrics collector 212 gathers data related to the performance of the asynchronous monitoring system 114, such as processing times, success rates, and queue lengths. It communicates with the data storage 218 to persist collected metrics for historical analysis and with the SLO management platform 210 to provide real-time performance data.

In some example embodiments, the metrics collector 212 defines two categories of events for calculating SLOs: valid events and good events.

Valid events are defined as all the events processed by the asynchronous pipeline, which includes the event source 202, event queue 204, asynchronous processor 206, and response queue 208. This category encompasses every event that enters the asynchronous monitoring system 114 for processing.

Good events, however, represent a subset of the valid events. These events are characterized by their successful processing within a predetermined time frame. This time frame accounts for both the waiting time in the queue (e.g., event queue 204) and the processing time within the asynchronous processor 206. An event is classified as good if it has neither failed nor been retried and meets the success criteria within the specified time limits.

The queue waiting time for events can vary based on several factors, including the nature of the event, the order in which events are queued, and the system's prioritization policies. Example factors for different wait times include event characteristics, order of occurrence, system load, and resources. An example of event characteristics includes events related to system health monitoring, which might be prioritized over routine data processing tasks. An example of order of occurrence includes events that are processed in the order they arrive in the queue (FIFO—First In, First Out), but this can be adjusted based on priority levels assigned to different types of events. An example of system load and resources include a load on the system and available processing resources (e.g., during peak loads, events may experience longer wait times).

Other example factors related to queue waiting time for events include queue prioritization and parallel processing. In queue prioritization, the event queue 204 implements prioritization strategies to ensure that high-priority events are processed more quickly. This can be achieved through priority queues, where events are assigned different priority levels, and the queue processes higher-priority events first. In parallel processing, some events have the same wait time if they are processed in parallel.

In some example embodiments, the asynchronous application 120 determines the queue wait time by recording a timestamp when an event is enqueued in the event queue 204 and another timestamp when the event is dequeued for processing. By calculating the difference between these timestamps, the asynchronous application 120 can accurately measure the queue waiting time for each event.

In some example embodiments, the metrics collector 212 and/or the SLO management platform 210 computes an availability metric and a latency metric based on the asynchronous events from event source 202.

The availability metric for asynchronous events is calculated by evaluating the proportion of successful events relative to the total events processed by the system over a defined time period. Successful events are those that meet predefined success criteria, such as being processed without errors and within a specified time frame. These events are marked as successful in the response queue after processing. Total events include all events that have been processed by the system, regardless of their outcome. This encompasses both successful and unsuccessful events, providing a comprehensive view of the system's workload. The availability metric is determined by dividing the number of successful events by the total number of events. This ratio is typically expressed as a percentage, representing the system's ability to process events successfully.

One example formula for the availability metric can be expressed as:
Availability Metric=(Number of Successful Events/Number of Total Events)×100%

The latency metric is calculated by considering the total time an event spends in the system, from its entry into the event queue 204 to its exit from the response queue 208. For example, the total time includes queue waiting time at the event queue 204, processing time at the asynchronous application 120, and response queue time at the response queue 208.

The latency metric is then determined by summing the queue waiting time, the processing time, and the response queue time for each event. This total time is compared against a predetermined latency threshold to assess whether the event was processed within preset limits.

The alerting system 214 generates alerts based on the evaluation of collected metrics against defined SLOs. It receives input from the SLO management platform 210 and determines whether any SLO violations have occurred. The alerting system 214 can be configured to send notifications through various channels, such as email, or to integrate with incident management platforms. Additionally, the SLO management platform 210 interfaces with the user interface application 216, allowing users to configure alert settings and view alert history. In some example embodiments, the SLO management platform 210 dynamically adjusts the SLO based on historical performance data and predicted future load on the asynchronous application 120.

The user interface application 216 provides a graphical interface for users to interact with the asynchronous monitoring system 114. It allows users to configure SLOs, view performance metrics, and manage alerts. The user interface application 216 communicates with the SLO management platform 210 to retrieve and display SLO configurations and performance data, and with the alerting system 214 to provide users access to alert settings and notifications. In some example embodiments, the user interface application 216 integrates metrics of the service level objective in a centralized monitoring system that provides a comprehensive view of system performance.

The data storage 218 holds information related to the performance of the asynchronous monitoring system 114, including metrics collected by the metrics collector 212 and historical event data (e.g., successful and total events). For instance, the data storage 218 may employ a scalable and reliable database system capable of managing large volumes of data. It ensures that historical performance data is available for analysis and reporting, enabling system operators to identify trends and make informed decisions.

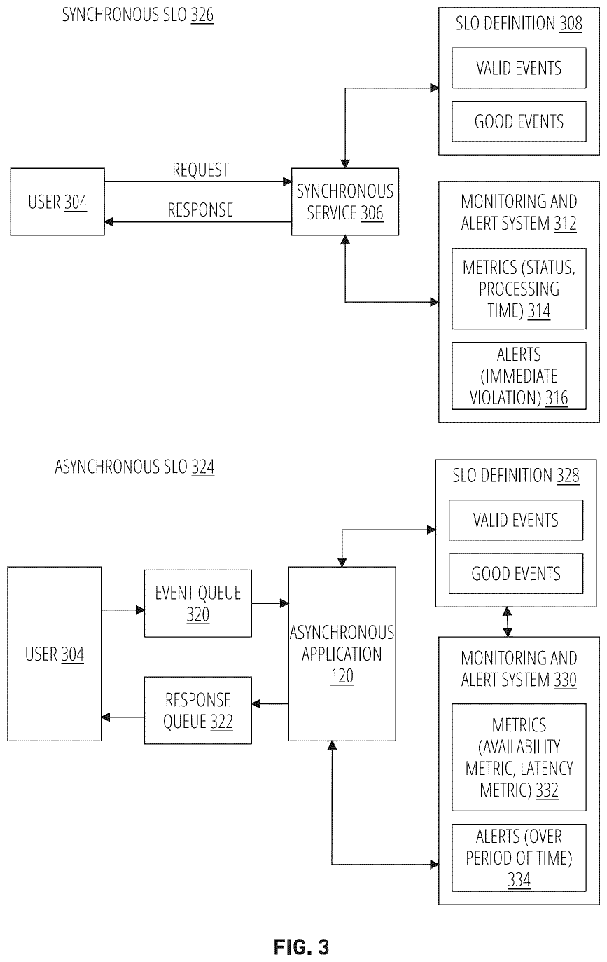

FIG. 3 is a block diagram illustrating the integration of synchronous and asynchronous SLOs with monitoring and alert systems in accordance with some example embodiments. The user 304 interacts with both synchronous and asynchronous systems, initiating requests that are processed differently depending on the system type.

In synchronous systems, such as synchronous SLO 326, user 304 sends a request to synchronous service 306, which processes the request and provides an immediate response. This interaction features a direct feedback loop, where user 304 expects a prompt reply from the synchronous service 306.

The synchronous service 306 handles user requests in real time and operates under a synchronous SLO 326. The synchronous SLO 326 is based on the SLO definition 308, which outlines the criteria for valid and good events. Valid events encompass all incoming requests, while good events refer to those successfully processed and responded to within a specified timeframe. The synchronous service 306 is monitored by a monitoring and alert system 312, which tracks metrics such as response time and success rate (e.g., metrics 314). If the service fails to meet the defined SLO, immediate violation alerts (e.g., alert 316) are generated to inform system administrators of potential issues.

In asynchronous systems, such as asynchronous SLO 324, the user 304 submits events to an event queue 320, where they are stored until processed by the asynchronous processor 318. The asynchronous processor 318 handles events without the need for immediate feedback, allowing for more flexible processing times. The SLO definition 328 may refer to jobs or functions, by the asynchronous application 120, with a database (e.g., reading/writing) or interactions with other sync or async applications.

The valid and good events of the SLO definition 328, unlike the SLO definition 308, also includes considerations for queue time and processing time. For example, the monitoring and alert system 330 tracks metrics 332 (e.g., availability metric, latency metric), including the combined queue and processing time, as well as success rate. Alerts over a specified period (e.g., alerts 334) are generated if the asynchronous system fails to meet the defined SLO, employing a different approach to monitoring and alerting compared to the immediate alerts utilized in synchronous systems.

In some example embodiments, “good events” of the SLO definition 328 are defined as those events that are successfully processed within a specified time frame. This time frame includes both the duration spent in the event queue 320 and the processing time by the asynchronous processor 318. In contrast, “valid events” of the SLO definition 328 comprise all events processed by the pipeline, regardless of the outcome of their processing.

The example of the SLO definition 328 and the monitoring and alert system 330 allows for capturing the temporal dynamics and success criteria of event processing. For instance, in a data streaming application, a good event might be one that is processed and acknowledged within 500 milliseconds, while a valid event includes all events that enter the processing pipeline, even those that fail or need to be retried. This approach provides a more comprehensive and realistic assessment of system performance, enabling better accountability in asynchronous systems.

The event queue 320 serves as temporary storage for events submitted by the user 304, enabling the asynchronous processor 318 to process these events at its own pace. This separation of event submission and processing allows the system to manage varying loads without compromising user experience. The response queue 322 collects the results of processed events, providing a mechanism for delivering responses back to the user 304 once processing is complete.

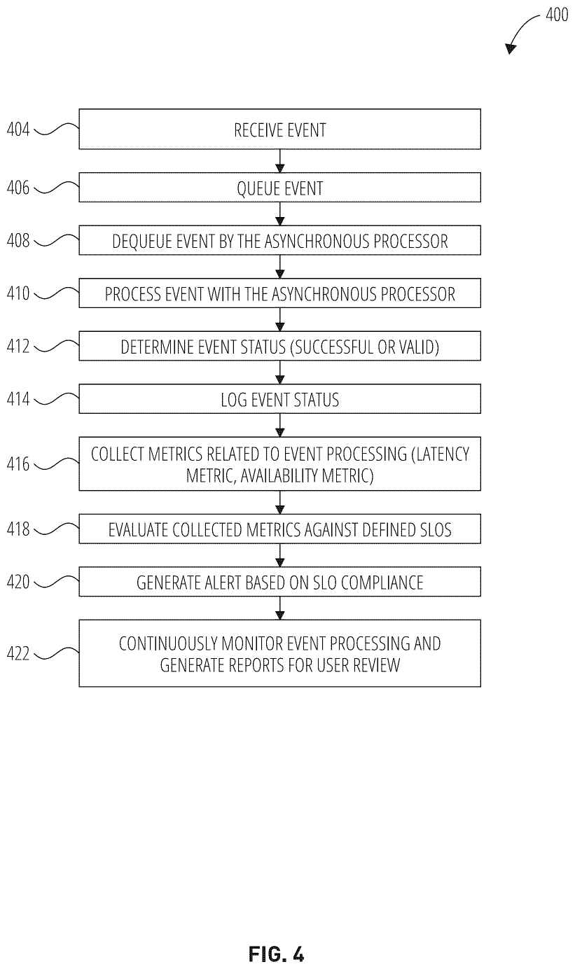

FIG. 4 shows a method 400 for handling events in an asynchronous pipeline. The method 400 is implemented by an asynchronous monitoring system 114 to manage and evaluate the processing of asynchronous events, ensure compliance with SLOs 324, and generate alerts (at step 420) and reports (at step 422).

At step 404, the method 400 begins with receiving an event 404. This step involves capturing an incoming event that needs to be processed by the asynchronous processor 318.

At step 406, the event is queued. This involves placing the received event into an event queue 320, where the event awaits processing by the asynchronous processor 318.

At step 408, the event is dequeued by the asynchronous processor 318. This step involves removing the event from the queue to be processed by the asynchronous application.

At step 410, the event is processed with the asynchronous processor 318. The asynchronous processor 318 handles the event, performing computations or operations to generate an outcome.

At step 412, the asynchronous application determines the event status, categorizing the event as successful or valid. This involves assessing the processing outcome to establish whether the event was handled successfully or if the event meets certain validity criteria.

At step 414, the event status is logged. This step involves recording the status of the event in a metrics database for future reference and analysis.

At step 416, metrics (latency metric and availability metric) related to event processing, such as latency and success rate, are collected. This involves gathering data on various performance indicators associated with the event processing.

At step 418, the collected metrics are evaluated against defined SLOs. This step involves comparing the gathered metrics to pre-established service level objectives to determine compliance.

At step 420, an alert is generated based on SLO compliance. If the evaluation indicates a deviation from the defined SLOs, an alert notification is created to inform relevant stakeholders.

At step 422, method 400 continuously monitors event processing and generates reports for user review. This involves ongoing observation of the event processing activities and compiling reports that provide insights into system performance and compliance with SLOs.

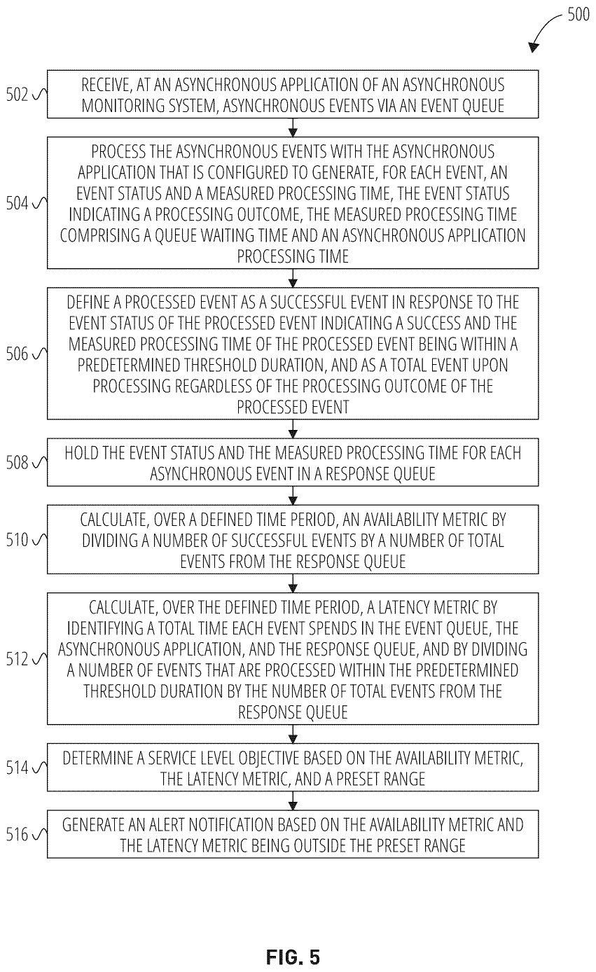

FIG. 5 illustrates a routine in accordance with some example embodiments. In block 502, routine 500 receives, at an asynchronous application of an asynchronous monitoring system, asynchronous events via an event queue. The data collection can then be used for metrics, traces, alters, recording rules, and anomaly detection. Although the example routine 500 depicts a particular sequence of operations, the sequence may be altered without departing from the scope of the present disclosure. For example, some of the operations depicted may be performed in parallel or in a different sequence that does not materially affect the function of the routine 500. In other examples, different components of an example device or system that implements the routine 500 may perform functions at substantially the same time or in a specific sequence.

In block 502, routine 500 receives, at an asynchronous application of an asynchronous monitoring system, asynchronous events via an event queue. In block 504, routine 500 processes the asynchronous events with the asynchronous application (e.g., asynchronous processor 206) that is configured to generate, for each event of the asynchronous events, an event status and a measured processing time, the event status indicating a processing outcome, the measured processing time comprising a queue waiting time and an asynchronous application processing time.

In block 506, routine 500 defines a processed event as a successful event when the event status of the processed event indicates a success and the measured processing time of the processed event is within a predetermined threshold, and as a total event upon processing regardless of the processing outcome of the processed event.

In block 508, routine 500 holds the event status and the measured processing time for each asynchronous event in a response queue.

In block 510, routine 500 calculates, over a defined time period, an availability metric by dividing the number of successful events by the number of total events from the response queue. By calculating the availability metric over the defined time period, the system can evaluate its performance and reliability during that period. For example, a higher availability metric indicates that a large proportion of events were processed successfully, suggesting that the system is performing well. Conversely, a low availability metric may signal potential issues that are to be addressed to improve system reliability.

In block 512, routine 500 calculates, over the defined time period, a latency metric by identifying the total time each event spends in the event queue, the asynchronous application, and the response queue and by dividing a number of events that are processed within the predetermined threshold duration by the number of total events from the response queue.

In block 514, routine 500 determines a service level objective based on the availability metric, the latency metric, and a preset range (e.g., an availability preset range and a latency preset range). In some example embodiment, routine 500 is performed at the asynchronous monitoring system 114 or monitoring and alert system 330.

The term “availability preset range” refers to a predefined threshold or set of thresholds that specify acceptable levels of availability for the system. The availability preset range defines the minimum percentage of successful events required over a given time period to meet the service level objective (SLO). For example, an availability preset range might be set at 99%, meaning that at least 99% of events must be processed successfully to meet the SLO.

The term “latency preset range” refers to a predefined threshold or set of thresholds that specify the acceptable levels of latency for the system. The latency preset range defines the maximum allowable time for processing events to meet the SLO. For example, a latency preset range might be set at 200 milliseconds, meaning that events should be processed within this time frame to meet the SLO.

The preset ranges (e.g., availability and latency) are tied to the service level objectives, which are targets set to ensure system performance and reliability. If the SLOs are adjusted, the preset ranges may also change to reflect new performance goals. For instance, if the system aims to improve its reliability, the availability preset range might be increased from 99% to 99.9%. Similarly, if faster response times are desired, the latency preset range might be reduced from 200 milliseconds to 150 milliseconds.

In block 516, routine 500 generates an alert notification based on the availability metric and the latency metric being outside the preset range. For example, routine 500 generates alert notifications when service level objectives are violated, specifically when calculated availability metrics fall outside availability thresholds and/or latency metrics fall outside latency thresholds. The alert system notifies system administrators or operators through various channels, such as email or SMS, enabling a prompt response to potential issues that could affect service reliability. The service level objectives (SLOs) are dynamically adjusted based on historical performance data and predicted future loads on the asynchronous application. This involves analyzing past performance trends and using predictive analytics to anticipate future demands. The system can automatically recalibrate SLOs to ensure they remain relevant and achievable, optimizing resource allocation and maintaining service quality.

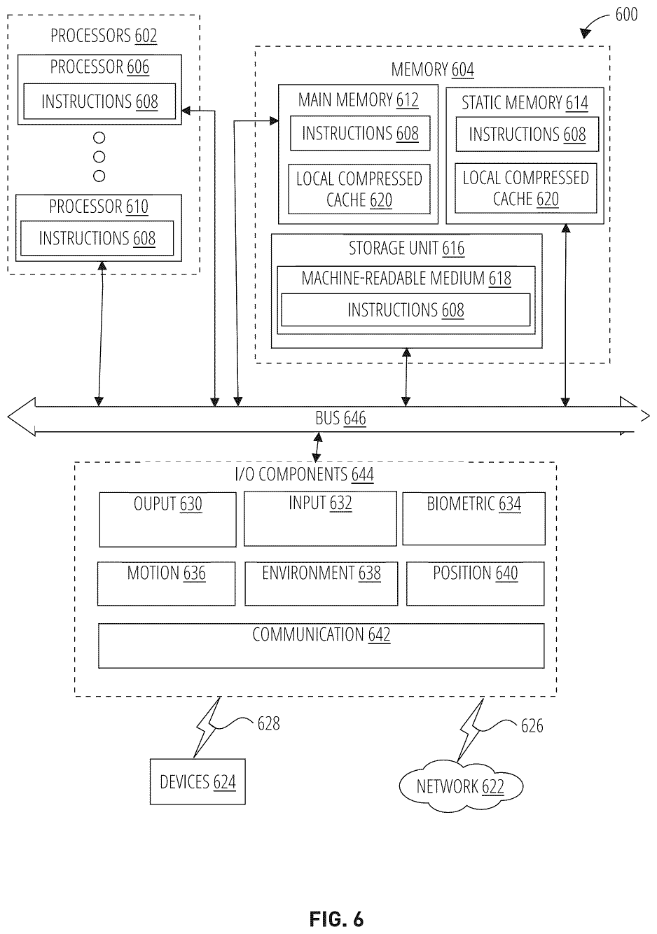

FIG. 6 is a diagrammatic representation of the machine 600 within which instructions 608 (e.g., software, a program, an application, an applet, an app, or other executable code) for causing the machine 600 to perform any one or more of the methodologies discussed herein may be executed. For example, the instructions 608 may cause the machine 600 to execute any one or more of the methods described herein. The instructions 608 transform the general, non-programmed machine 600 into a particular machine 600 programmed to carry out the described and illustrated functions in the manner described. The machine 600 may operate as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 608, sequentially or otherwise, that specify actions to be taken by the machine 600. Further, while only a single machine 600 is illustrated, the term “machine” shall also be taken to include a collection of machines that individually or jointly execute the instructions 608 to perform any one or more of the methodologies discussed herein.

The machine 600 may include Processors 602, memory 604, and I/O Components 644, which may be configured to communicate with each other via a bus 646. In an example embodiment, the Processors 602 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a Processor 606 and a Processor 610 that execute the instructions 608. The term “processor” is intended to include multi-core processors that may comprise two or more independent processors (sometimes referred to as “cores”) that may execute instructions contemporaneously. Although FIG. 6 shows multiple Processors 602, the machine 600 may include a single processor with a single core, a single processor with multiple cores (e.g., a multi-core processor), multiple processors with a single core, multiple processors with multiples cores, or any combination thereof.

The memory 604 includes a main memory 612, a static memory 614, and a storage unit 616, both accessible to the Processors 602 via the bus 646. The main memory 604, the static memory 614, and storage unit 616 store the instructions 608 embodying any one or more of the methodologies or functions described herein. The instructions 608 may also reside, completely or partially, within the main memory 612, within the static memory 614, within machine-readable medium 618 within the storage unit 616, within at least one of the Processors 602 (e.g., within the processor's cache memory), or any suitable combination thereof, during execution thereof by the machine 600.

The I/O Components 644 may include a wide variety of components to receive input, provide output, produce output, transmit information, exchange information, capture measurements, and so on. The specific I/O Components 644 that are included in a particular machine will depend on the type of machine. For example, portable machines such as mobile phones may include a touch input device or other such input mechanisms, while a headless server machine will likely not include such a touch input device. It will be appreciated that the I/O Components 644 may include many other components that are not shown in FIG. 6. In various example embodiments, the I/O Components 644 may include output Components 630 and input Components 632. The output Components 630 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input Components 632 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O Components 644 may include biometric Components 634, motion Components 636, environmental Components 638, or position Components 640, among a wide array of other Components. For example, the biometric Components 634 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 636 include acceleration sensor components (e.g., accelerometer), gravitation sensor components, rotation sensor components (e.g., gyroscope), and so forth. The environmental Components 638 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position Components 640 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O Components 644 further include communication Components 642 operable to couple the machine 600 to a network 622 or devices 624 via a coupling 626 and a coupling 628, respectively. For example, the communication Components 642 may include a network interface component or another suitable device to interface with the network 622. In further examples, the communication Components 642 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 624 may be another machine or any of a wide variety of peripheral devices (e.g., a peripheral device coupled via a USB).

Moreover, the communication Components 642 may detect identifiers or include Components operable to detect identifiers. For example, the communication Components 642 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication Components 642, such as location via Internet Protocol (IP) geolocation, location via Wi-Fi® signal triangulation, location via detecting an NFC beacon signal that may indicate a particular location, and so forth.

The various memories (e.g., memory 604, main memory 612, static memory 614, and/or memory of the Processors 602) and/or storage unit 616 may store one or more sets of instructions and data structures (e.g., software) embodying or used by any one or more of the methodologies or functions described herein. These instructions (e.g., the instructions 608), when executed by Processors 602, cause various operations to implement the disclosed embodiments.

The instructions 608 may be transmitted or received over the network 622, using a transmission medium, via a network interface device (e.g., a network interface Component included in the communication Components 642) and using any one of a number of well-known transfer protocols (e.g., hypertext transfer protocol (HTTP)). Similarly, the instructions 608 may be transmitted or received using a transmission medium via the coupling 628 (e.g., a peer-to-peer coupling) to the devices 624.

As used herein, the terms “Machine-Storage Medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1016 and/or data. The terms shall accordingly be taken to include, but not be limited to, solid-state memories, and optical and magnetic media, including memory internal or external to Processors. Specific examples of Machine-Storage Media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “Machine-Storage Medium,” “computer-storage medium,” and “device-storage medium” specifically exclude carrier waves, modulated data signals, and other such media, at least some of which are covered under the term “Signal Medium” discussed below.

In some examples, one or more portions of the network 622 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 622 or a portion of the network 622 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface Component included in the communication Components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 1070. The terms “transmission medium” and “Signal Medium” mean the same thing and may be used interchangeably in this disclosure. The terms “transmission medium” and “Signal Medium” shall be taken to include any intangible medium that is capable of storing, encoding, or carrying the instructions for execution by the machine, and include digital or analog communications signals or other intangible media to facilitate communication of such software. Hence, the terms “transmission medium” and “Signal Medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “Computer-Readable Medium,” and “device-readable medium” mean the same thing and may be used interchangeably in this disclosure. The terms are defined to include both Machine-Storage Media and transmission media. Thus, the terms include both storage devices/media and carrier waves/modulated data signals. For instance, an embodiment described herein can be implemented using a non-transitory medium (e.g., a non-transitory Computer-Readable Medium).

Throughout this specification, plural instances may implement resources, Components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate Components in example configurations may be implemented as a combined structure or Component. Similarly, structures and functionality presented as a single Component may be implemented as separate Components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

In view of the disclosure above, various examples are set forth below. It should be noted that one or more features of an example, taken in isolation or combination, should be considered within the disclosure of this application.

Example 1 is a method comprising: receiving, at an asynchronous application of an asynchronous monitoring system, asynchronous events via an event queue; generating, by the asynchronous application, for each of the asynchronous events, an event status and a measured processing time, the event status indicating a processing outcome, the measured processing time comprising a queue waiting time and an asynchronous application processing time; defining a processed asynchronous event as a successful event in response to the event status of the processed asynchronous event indicating a success and the measured processing time of the processed asynchronous event being within a predetermined threshold duration, and as a total event upon processing regardless of the processing outcome of the processed asynchronous event; and generating an alert notification based on a particular measured processing time, of one of the asynchronous events, not being within the predetermined threshold duration.

In Example 2, the subject matter of Example 1 includes, holding the event status and the measured processing time for each of the asynchronous events in a response queue.

In Example 3, the subject matter of Example 2 includes, calculating an availability metric by dividing a number of successful events by a number of total events based on the event status in the response queue.

In Example 4, the subject matter of Example 3 includes, calculating a latency metric by: identifying a total time each of the asynchronous events spends in the event queue, the asynchronous application, and the response queue.

In Example 5, the subject matter of Example 4 includes, dividing a number of the asynchronous events that have the measured processing time within the predetermined threshold duration by the number of total events from the response queue.

In Example 6, the subject matter of Examples 4-5 includes, generating an alert notification based on the availability metric and the latency metric being outside a preset range.

In Example 7, the subject matter of Example 6 includes, wherein the preset range comprises a latency preset range and an availability preset range.

In Example 8, the subject matter of Examples 1-7 includes, wherein the processing of the asynchronous events includes logging and storing the event status and processing time of each event in a metrics database.

In Example 9, the subject matter of Examples 1-8 includes, wherein the alert notification indicates a service level objective violation that is dynamically adjusted based on historical performance data and predicted future load on the asynchronous application.

In Example 10, the subject matter of Examples 1-9 includes, wherein the event queue and a response queue are part of a processing queue that is implemented as a distributed message queue of an asynchronous pipeline of the asynchronous monitoring system.

Example 11 is a computing apparatus comprising: a processor; and a memory storing instructions that, when executed by the processor, configure the computing apparatus to perform operations comprising: receiving, at an asynchronous application of an asynchronous monitoring system, asynchronous events via an event queue; generating, by the asynchronous application, for each of the asynchronous events, an event status and a measured processing time, the event status indicating a processing outcome, the measured processing time comprising a queue waiting time and an asynchronous application processing time; defining a processed asynchronous event as a successful event in response to the event status of the processed asynchronous event indicating a success and the measured processing time of the processed asynchronous event being within a predetermined threshold duration, and as a total event upon processing regardless of the processing outcome of the processed asynchronous event; and generating an alert notification based on a particular measured processing time, of one of the asynchronous events, not being within the predetermined threshold duration.

In Example 12, the subject matter of Example 11 includes, wherein the operations further comprise: holding the event status and the measured processing time for each of the asynchronous events in a response queue.

In Example 13, the subject matter of Example 12 includes, wherein the operations further comprise: calculating an availability metric by dividing a number of successful events by a number of total events based on the event status in the response queue.

In Example 14, the subject matter of Example 13 includes, wherein the operations further comprise: calculating a latency metric by: identifying a total time each of the asynchronous events spends in the event queue, the asynchronous application, and the response queue.

In Example 15, the subject matter of Example 14 includes, wherein the operations further comprise: dividing a number of the asynchronous events that have the measured processing time within the predetermined threshold duration by the number of total events from the response queue.

In Example 16, the subject matter of Examples 14-15 includes, wherein the operations further comprise: generating an alert notification based on the availability metric and the latency metric being outside a preset range.

In Example 17, the subject matter of Example 16 includes, wherein the preset range comprises a latency preset range and an availability preset range.

In Example 18, the subject matter of Examples 11-17 includes, wherein the processing of the asynchronous events includes logging and storing the event status and processing time of each event in a metrics database.

In Example 19, the subject matter of Examples 11-18 includes, wherein the alert notification indicates a service level objective violation that is dynamically adjusted based on historical performance data and predicted future load on the asynchronous application.

Example 20 is a non-transitory computer-readable storage medium including instructions that when executed by a computer, cause the computer to perform operations comprising: receiving, at an asynchronous application of an asynchronous monitoring system, asynchronous events via an event queue; generating, by the asynchronous application, for each of the asynchronous events, an event status and a measured processing time, the event status indicating a processing outcome, the measured processing time comprising a queue waiting time and an asynchronous application processing time; defining a processed asynchronous event as a successful event in response to the event status of the processed asynchronous event indicating a success and the measured processing time of the processed asynchronous event being within a predetermined threshold duration, and as a total event upon processing regardless of the processing outcome of the processed asynchronous event; and generating an alert notification based on a particular measured processing time, of one of the asynchronous events, not being within the predetermined threshold duration.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20. Example 24 is a method to implement of any of Examples 1-20.

What is claimed is:

1. A method comprising:
receiving, at an asynchronous application of an asynchronous monitoring system, asynchronous events via an event queue;
generating, by the asynchronous application, for each of the asynchronous events, an event status and a measured processing time, the event status indicating a processing outcome, the measured processing time comprising a queue waiting time and an asynchronous application processing time;
defining a processed asynchronous event as a successful event in response to the event status of the processed asynchronous event indicating a success and the measured processing time of the processed asynchronous event being within a predetermined threshold duration, and as a total event upon processing regardless of the processing outcome of the processed asynchronous event; and
generating an alert notification based on a particular measured processing time, of one of the asynchronous events, not being within the predetermined threshold duration.

2. The method of claim 1, further comprising:
holding the event status and the measured processing time for each of the asynchronous events in a response queue.

3. The method of claim 2, further comprising:
calculating an availability metric by dividing a number of successful events by a number of total events based on the event status in the response queue.

4. The method of claim 3, further comprising:
calculating a latency metric by: identifying a total time each of the asynchronous events spends in the event queue, the asynchronous application, and the response queue.

5. The method of claim 4, further comprising: dividing a number of the asynchronous events that have the measured processing time within the predetermined threshold duration by the number of total events from the response queue.

6. The method of claim 4, further comprising: generating an alert notification based on the availability metric and the latency metric being outside a preset range.

7. The method of claim 6, wherein the preset range comprises a latency preset range and an availability preset range.

8. The method of claim 1, wherein the processing of the asynchronous events includes logging and storing the event status and processing time of each event in a metrics database.

9. The method of claim 1, wherein the alert notification indicates a service level objective violation that is dynamically adjusted based on historical performance data and predicted future load on the asynchronous application.

10. The method of claim 1, wherein the event queue and a response queue are part of a processing queue that is implemented as a distributed message queue of an asynchronous pipeline of the asynchronous monitoring system.

11. A computing apparatus comprising:
a processor; and
a memory storing instructions that, when executed by the processor, configure the computing apparatus to perform operations comprising:
receiving, at an asynchronous application of an asynchronous monitoring system, asynchronous events via an event queue;
generating, by the asynchronous application, for each of the asynchronous events, an event status and a measured processing time, the event status indicating a processing outcome, the measured processing time comprising a queue waiting time and an asynchronous application processing time;
defining a processed asynchronous event as a successful event in response to the event status of the processed asynchronous event indicating a success and the measured processing time of the processed asynchronous event being within a predetermined threshold duration, and as a total event upon processing regardless of the processing outcome of the processed asynchronous event; and
generating an alert notification based on a particular measured processing time, of one of the asynchronous events, not being within the predetermined threshold duration.

12. The computing apparatus of claim 11, wherein the operations further comprise:
holding the event status and the measured processing time for each of the asynchronous events in a response queue.

13. The computing apparatus of claim 12, wherein the operations further comprise:
calculating an availability metric by dividing a number of successful events by a number of total events based on the event status in the response queue.

14. The computing apparatus of claim 13, wherein the operations further comprise:
calculating a latency metric by: identifying a total time each of the asynchronous events spends in the event queue, the asynchronous application, and the response queue.

15. The computing apparatus of claim 14, wherein the operations further comprise:
dividing a number of the asynchronous events that have the measured processing time within the predetermined threshold duration by the number of total events from the response queue.

16. The computing apparatus of claim 14, wherein the operations further comprise:
generating an alert notification based on the availability metric and the latency metric being outside a preset range.

17. The computing apparatus of claim 16, wherein the preset range comprises a latency preset range and an availability preset range.

18. The computing apparatus of claim 11, wherein the processing of the asynchronous events includes logging and storing the event status and processing time of each event in a metrics database.

19. The computing apparatus of claim 11, wherein the alert notification indicates a service level objective violation that is dynamically adjusted based on historical performance data and predicted future load on the asynchronous application.

20. A non-transitory computer-readable storage medium including instructions that when executed by a computer, cause the computer to perform operations comprising:
receiving, at an asynchronous application of an asynchronous monitoring system, asynchronous events via an event queue;
generating, by the asynchronous application, for each of the asynchronous events, an event status and a measured processing time, the event status indicating a processing outcome, the measured processing time comprising a queue waiting time and an asynchronous application processing time;
defining a processed asynchronous event as a successful event in response to the event status of the processed asynchronous event indicating a success and the measured processing time of the processed asynchronous event being within a predetermined threshold duration, and as a total event upon processing regardless of the processing outcome of the processed asynchronous event; and
generating an alert notification based on a particular measured processing time, of one of the asynchronous events, not being within the predetermined threshold duration.
